(19) United States
(12) Patent Application Publication
(10) Pub. No.: US 2025/0092527 A1
(43) Pub. Date: Mar. 20, 2025

(54) METHOD FOR PREPARING RADIATIVE COOLING METAMATERIAL BY POWDER COATING

(71) Applicant: IUCF-HYU (INDUSTRY-UNIVERSITY COOPERATION FOUNDATION HANYANG UNIVERSITY), Seoul (KR)

(72) Inventors: Dong Rip KIM, Seoul (KR); Kang Won LEE, Seoul (KR); Jonghun YI, Busan (KR); Yale JEON, Incheon (KR)

(73) Assignee: IUCF-HYU (INDUSTRY-UNIVERSITY COOPERATION FOUNDATION HANYANG UNIVERSITY), Seoul (KR)

(21) Appl. No.: 18/726,680

(22) PCT Filed: Dec. 29, 2022
(86) PCT No.: PCT/KR2022/021598

§ 371 Date: Jul. 3, 2024

(30) Foreign Application Priority Data
Jan. 5, 2022 (KR) 10-2022-0001384
Nov. 30, 2022 (KR) 10-2022-0164492

(51) Int. Cl. C23C 24/08

(52) U.S. Cl. CPC C23C 24/085

(57) ABSTRACT

The present invention relates to a method for preparing a metamaterial in the form of a film having high visible light transmittance and excellent radiative cooling characteristics even with a small thickness by powder coating. In the present invention, a metamaterial in the form of a highly transparent film can be prepared by powder coating of aerogel particles, an optical modulator, and a base resin. The metamaterial formed according to the present invention can exhibit excellent visible light transmittance and heat dissipation characteristics and, since a powder coating process is used, a metamaterial coating can be formed regardless of the shape of an object and the coating can be thin and uniform.

### TECHNICAL FIELD

The present disclosure relates to a method for preparing a metamaterial having radiative cooling characteristics by powder coating, and more particularly, to a method for preparing a metamaterial in the form of a film having high visible light transmittance and excellent radiative cooling characteristics even with a small thickness by powder coating.

### BACKGROUND ART

Radiative cooling is a phenomenon that occurs when an object radiates heat in the form of infrared radiation. When the amount of radiation emitted from an object is more than the energy absorbed, radiative cooling phenomenon occurs and the temperature of the object decreases, and radiative cooling technologies that can utilize this characteristic to realize a cooling effect without external energy input are gaining attention.

In particular, the atmosphere does not absorb electromagnetic waves in a wavelength range of 8 to 13 μm, called an atmospheric window region, so the electromagnetic waves in that region are characterized by being emitted outside from the Earth. Therefore, research is being conducted to increase the cooling effect by enhancing the radiation from the atmospheric window region.

For example, Korean Patent Publication No. 10-2020-0061074 discloses a technology for enhancing radiative cooling performance by forming a lattice patterning structure in a PDMS thin film to have a high emissivity in the atmospheric window region to enhance a radiative cooling effect. In addition, Korean Patent No. 10-2036071 relates to a multi-layer radiative cooling structure that is attached to a cooling object to reduce a temperature of the cooling object, and discloses a radiative cooling structure including a dielectric layer and a metal thin film layer that absorb and radiate mid-infrared radiation.

As such, when radiative cooling materials are used, it allows objects to efficiently emit infrared radiation, providing a simple cooling effect without consuming electricity. For example, optoelectronic devices generate heat during operation, which reduces their efficiency. However, the efficiency of the device may be improved by applying a radiative cooling material in the form of a film to dissipate the heat.

However, general radiative cooling materials have the characteristics of reflecting most of the incident light, resulting in reflection of visible light and low transparency. In addition, radiative cooling films are generally prepared by using a liquid coating process. However, such a liquid coating process has a problem in that it is difficult to form a uniform coating on heat dissipation member with various three-dimensional structures such as a heat sink and a fin, and to control the thickness a thin thickness.

In this situation, the inventors of the present disclosure completed the present disclosure by finding that by using aerogel particles and an optical modulator in combination and powder coating the same, it is possible to form a metamaterial in the form of a film with excellent emissivity and transparency, and to apply a uniform coating to a three-dimensional heat dissipation member.

### DISCLOSURE

### Technical Problem

Object of the present disclosure is to provide a method for preparing a metamaterial with excellent transparency and radiative cooling performance by powder coating.

### Technical Solution

The present disclosure provides a method for preparing a metamaterial in the form of a film using powder coating.

In one embodiment of the present disclosure, a method for preparing the metamaterial may include: mixing and solidifying aerogel particles, an optical modulator, and a base resin to prepare a powder; powder coating the powder to form a powder layer; and heat treating the powder layer to form a metamaterial in the form of a film.

In another embodiment of the present disclosure, a method for preparing the metamaterial may include: mixing and solidifying aerogel particles and an optical modulator to prepare a powder; powder coating the powder and then coating a base resin to form a powder layer coated with the base resin, or mixing the powder with a base resin and then powder coating it; and heat treating the powder layer to form a metamaterial in the form of a film.

In still another embodiment of the present disclosure, a method for preparing the metamaterial may include: powder coating aerogel particles to form a powder layer; coating the powder layer with an optical modulator; coating the optical modulator-coated layer with a base resin; and heat treating the powder layer coated with the optical modulator and base resin to form a metamaterial in the form of a film.

In the present disclosure, the powder coating may be performed by an electrostatic spray method or a fluidized bed method.

In the present disclosure, the heat treatment may be performed at a temperature condition of 80 to 380° C.

In the present disclosure, the base resin may have a refractive index of 1.2 to 1.8.

In the present disclosure, the base resin may be one or more selected from the group consisting of polyvinylidene fluoride (PVDF), 2,2,2-trifluoroethyl methacrylate (TFEMA), polyethylene (PE), polypropylene (PP), polydimethylsiloxane (PDMS), polyimide (PI), colorless polyimide (CPI), perfluoropolyether (PFPE), polyurethane (PU), polycarbonate (PC), polystyrene (PS), polyester, and polyamide.

In the present disclosure, the aerogel particles may be one or more selected from the group consisting of silica (SiO₂) aerogels, titania (TiO₂) aerogels, carbon aerogels, and graphene aerogels.

In the present disclosure, the optical modulator may be an organic compound having a difference in refractive index of 0.05 or less from the base resin.

In the present disclosure, the optical modulator may be one or more selected from the group consisting of eicosane, n-hexadecane, and n-docosane.

In the present disclosure, a particle size of the powder may be 100 nm to 25 μm.

In the present disclosure, the metamaterial in the form of a film may have a thickness of 1 μm to 1 mm.

In the present disclosure, the metamaterial in the form of a film may have a visible light transmittance of 70% or more.

In the present disclosure, the metamaterial in the form of a film may have a surface roughness (Ra) of 5 to 50 μm.

In the present disclosure, the body to be coated on which the metamaterial in the form of a film is formed may be a heat sink, a heat dissipation fin, a cooling plate, or a solar cell.

### Advantageous Effects

In the present disclosure, a metamaterial in the form of a highly transparent film may be prepared by powder coating aerogel particles, an optical modulator, and a base resin. The metamaterial formed according to the present disclosure may exhibit excellent visible light transmittance and heat dissipation characteristics, and since a powder coating process is used, a metamaterial coating may be formed regardless of the shape of an object, and a uniform coating with a thin thickness is possible.

### DESCRIPTION OF DRAWINGS

FIG. 1 is a process diagram of a method for powder coating a metamaterial according to one embodiment of the present disclosure.

FIG. 2 is a process diagram of a method for powder coating a metamaterial according to another embodiment of the present disclosure.

FIG. 3 is a process diagram of a method for powder coating a metamaterial according to still another embodiment of the present disclosure.

FIG. 4 is a process diagram of a method for powder coating a metamaterial according to still another embodiment of the present disclosure.

FIG. 5 is a photograph of a process for forming a PVDF metamaterial film by powder coating in accordance with one embodiment of the present disclosure.

FIG. 6 is a photograph of a process for forming a PDMS metamaterial film by powder coating in accordance with one embodiment of the present disclosure.

FIG. 7 is a photograph of a process for forming a PDMS metamaterial film by powder coating in accordance with another embodiment of the present disclosure.

FIG. 8 is a graph obtained by measuring the visible light transmittance of a metamaterial film formed by powder coating in accordance with one embodiment of the present disclosure.

FIG. 9 is photographs before and after thermal fusion in a process for forming a metamaterial film on an aluminum substrate by powder coating in accordance with one embodiment of the present disclosure.

FIG. 10 is a graph obtained by measuring a temperature change of a metamaterial film formed by powder coating in accordance with one embodiment of the present disclosure.

FIG. 11 is a graph obtained by measuring visible light transmittance and haze factor of a metamaterial film formed by powder coating in accordance with one embodiment of the present disclosure.

FIG. 12 illustrates the results of a surface roughness analysis of a metamaterial film formed by powder coating in accordance with one embodiment of the present disclosure.

FIG. 13 is a graph obtained by measuring the visible light transmittance of a metamaterial film formed by powder coating in accordance with one embodiment of the present disclosure.

FIG. 14 is a photograph illustrating a difference in transparency in the presence and absence of eicosane in a metamaterial film formed by powder coating according to one embodiment of the present disclosure.

FIG. 15 is a graph obtained by measuring a temperature change of a metamaterial film formed on an aluminum substrate by powder coating in accordance with one embodiment of the present disclosure.

FIG. 16 is a graph obtained by measuring temperature change of a metamaterial film formed on a solar cell by powder coating in accordance with one embodiment of the present disclosure.

FIG. 17 is a photograph of a metamaterial film formed on a heat sink by powder coating in accordance with one embodiment of the present disclosure.

FIG. 18 is a photograph of a metamaterial film formed on a heat sink by powder coating in accordance with another embodiment of the present disclosure.

### BEST MODE

Specific aspects of the present disclosure will be described in more detail below. Unless otherwise defined, all technical and scientific terms used in the present specification have the same meaning as commonly understood by a person skilled in the art to which the present disclosure pertains. In general, the nomenclature used herein is well known and commonly used in the art.

The present disclosure relates to a method for preparing a metamaterial in the form of a film using powder coating.

Metamaterials refer to a material that may artificially control the interaction of light with matter by periodically arranging artificial structures that are larger than atoms and much smaller than the wavelength of incident light. Metamaterials exhibit properties that control light, waves, and electromagnetic waves in ways that are impossible with natural materials, and may be used in various applications, such as displays, automobiles, and aircraft depending on their material properties.

Generally, metamaterial films are prepared in a liquid phase using liquid spin coating, etc. However, there was a problem that coating was impossible if the object to be coated had a curved shape or a three-dimensional shape.

The present disclosure can solve this problem by forming a metamaterial coating regardless of the shape of the object using powder coating, which is easy to form a film with a thin thickness. In addition, even when powder coating is used in accordance with the present disclosure, the metamaterial may exhibit visible light transmittance and heat dissipation characteristics comparable to those of a liquid coating process.

The method of powder coating of metamaterials according to the present disclosure may be performed by using aerogel particles, an optical modulator, and a base resin.

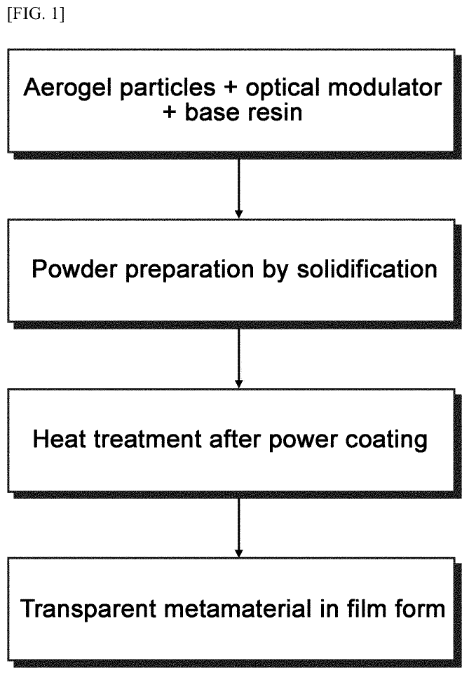

FIG. 1 is a process diagram of a method for preparing a metamaterial according to one embodiment of the present disclosure. In the embodiment above, a method for preparing the metamaterial may include: mixing and solidifying aerogel particles, an optical modulator, and a base resin to prepare a powder; powder coating the powder to form a powder layer; and heat treating the powder layer to form a metamaterial in the form of a film. Here, the optical modulator may be mixed in a liquid phase, and the base resin may be mixed in a liquid or solid phase.

In another embodiment of the present disclosure, a method for preparing the metamaterial may include: mixing and solidifying aerogel particles and an optical modulator to prepare a powder; powder coating the powder and then coating a base resin to form a powder layer coated with the base resin, or mixing the powder with a base resin and then powder coating it; and heat treating the powder layer to form a metamaterial in the form of a film. Here, the optical modulator may be mixed in a liquid phase, and the base resin may be coated or mixed in a liquid or solid phase.

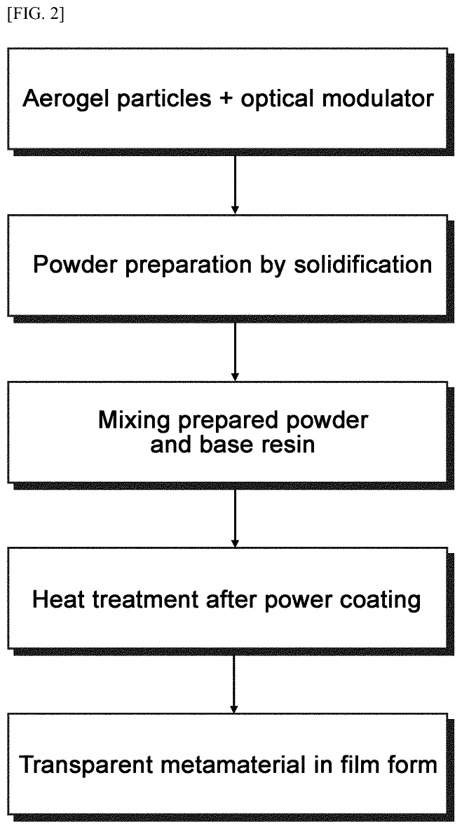

FIG. 2 is a process diagram of a method for preparing a metamaterial according to one embodiment of the present disclosure. In the embodiment above, the preparation method may include: mixing and solidifying aerogel particles and an optical modulator to prepare a powder; mixing the powder with a base resin to prepare a mixture; powder coating the mixture to form a powder layer; and heat treating the powder layer to form a metamaterial in the form of a film. Here, the optical modulator may be mixed in a liquid phase, and the base resin may be mixed in a solid phase.

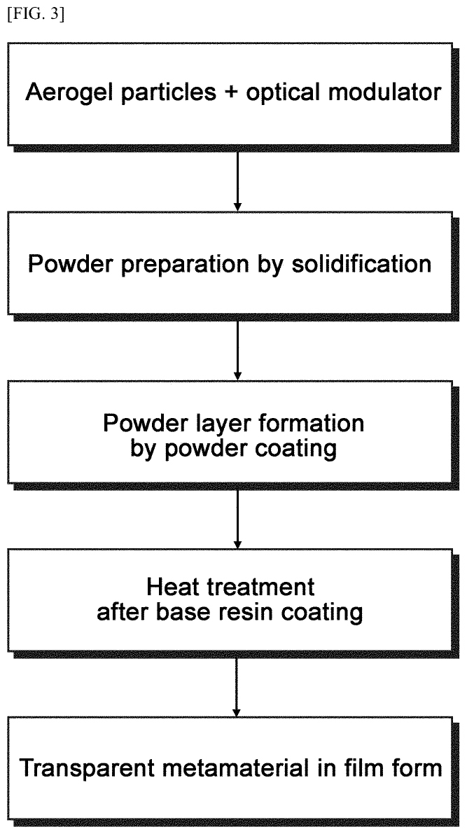

FIG. 3 is a process diagram of a method for preparing a metamaterial according to one embodiment of the present disclosure. In the embodiment above, the preparation method may include: mixing and solidifying aerogel particles and an optical modulator to prepare a powder; powder coating the powder to form a powder layer; coating the powder layer with a base resin; and heat treating the powder layer coated with the base resin to form a metamaterial in the form of a film. Here, the optical modulator may be mixed in a liquid phase, and the base resin may be coated in a liquid phase.

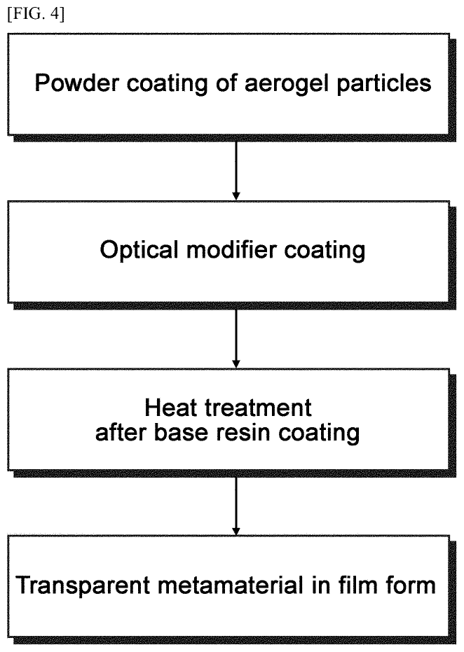

FIG. 4 is a process diagram of a method for preparing a metamaterial according to one embodiment of the present disclosure. In the embodiment above, the preparation method may include: powder coating aerogel particles to form a powder layer; coating the powder layer with an optical modulator; coating the optical modulator-coated layer with a base resin; and heat treating the powder layer coated with the optical modulator and base resin to form a metamaterial in the form of a film. Here, the optical modulator may be coated in a liquid phase, and the base resin may be coated in a liquid phase, or powder coated in a solid phase.

In the present disclosure, various powder coating processes using aerogel particles, an optical modulator, and a base resin may be used to form metamaterial coatings with excellent transparency and radiative cooling characteristics. In addition, since powder coating is used, metamaterial coatings may be formed on the object to be coated having complex three-dimensional structures, such as heat sinks and cooling plates, and coatings with a thin thickness may be formed stably.

In the present disclosure, the object to be coated, which is a powder coating target, may be a two-dimensional flat substrate as well as a curved substrate, and may further have a three-dimensional structure. For example, in the present disclosure, the object to be coated may be a heat dissipation member such as a heat sink, a cooling plate, etc., and in particular, the metamaterial formed by powder coating according to the present disclosure may be applied to the heat dissipation member to improve radiative cooling performance.

Before performing the powder coating of the present disclosure, one or more of the steps of sanding, degreasing, and washing the object to be coated may be further performed. Accordingly, it is possible to improve the uniformity and coating stability of the powder coating.

In the present disclosure, the powdering process for powder coating may be performed by mixing the corresponding components, then solidifying and grinding them. Specifically, when powdering the mixture of aerogel particles and an optical modulator; or a mixture of aerogel particles, an optical modulator and a base resin, the powder may be obtained by drying after mixing, or by grinding the solidified mixture through temperature control. Here, the grinding method may utilize methods such as rotary grinding, freeze grinding, etc.

In the present disclosure, when the optical modulator and/or base resin are mixed with the aerogel particles, and powdered, the optical modulator may be mixed in a liquid phase and the base resin may be mixed in a liquid or solid phase depending on the resin characteristics. Specifically, when the base resin is a thermosetting resin, it may be mixed in a liquid phase, and if the base resin is a thermoplastic resin, it may be mixed in a solid phase. When mixing a solid resin as a base resin, the base resin in the form of pellets may be grounded to prepare a powder form and then used.

In the process of the present disclosure, when the base resin is coated separately without forming a powder layer together with the aerogel particles, the base resin may be coated in a liquid phase. Additionally, when the optical modulator is coated separately without forming a powder layer with the aerogel particles, the optical modulator may be coated in a liquid phase. Alternatively, it is also possible to solidify the base resin or optical modulator under temperature conditions at or below its melting point, grind it and coat it with powder coating.

The liquid coating of the base resin or optical modulator may be performed using a conventional liquid coating method, such as spin coating, spray coating, dip coating, doctor blade, etc.

In the present disclosure, a particle size of the powder applied to the powder coating process may be 100 nm to 25 μm, and may be preferably adjusted to 1 to 10 μm. The thickness of the powder layer formed by powder coating may be reduced by a subsequent heat treatment process.

In the present disclosure, the powder coating process may be performed by using a known powder coating method, such as an electrostatic spray method, a fluidized bed method, etc. Preferably, the electrostatic spray method may be applied in the present disclosure. Specifically, the particles may be powdered, then air may be injected into the powder to fluidize the powdered particles to make the powder behave more like a liquid to facilitate powder coating, and then the fluidized particles may be charged and applied to a surface to be coated via electrostatic attraction.

In the present disclosure, a transparent metamaterial may be formed by heat treatment after completing the powder coating. Before heat treatment, the metamaterial is opaque due to the powder layer formed by the powder coatings, but after heat treatment, the metamaterial is formed and converted into a coating with excellent transparent. In the present disclosure, the heat treatment temperature may be adjusted in a range of 80 to 380° C. in consideration of the characteristics of the base resin and the optical modulator. In the exemplified embodiment of the present disclosure, the heat treatment may be performed at a temperature condition of 150 to 380° C. By this heat treatment, a transparent metamaterial layer is formed with a decrease in surface roughness and an increase in visible light transmittance.

As such, in the powder coating process of the present disclosure, the aerogel particles, an optical modulator, and a base resin may be combined through heat treatment after coating to form a metamaterial that is transparent and has excellent heat dissipation.

According to the process of the present disclosure, a metamaterial in the form of a film may be formed by a simple process of mixing and powder coating the aerogel particles, an optical modulator and a base resin at once, alternatively, the metamaterial may be formed by coating the aerogel particles, an optical modulator and a base resin separately. Furthermore, by adjusting the process conditions such as temperature in consideration of the type and properties of the base resin, various types of base resins may be applied to the process of the present disclosure to prepare metamaterials with excellent optical properties.

In the present disclosure, the base resin refers to a material that serves as the base of the film, and a conventional light-transmissive polymer resin used in the preparation of films may be used.

Specifically, in the present disclosure, one or more of polyvinylidene fluoride (PVDF), 2,2,2-trifluoroethyl methacrylate (TFEMA), polyethylene (PE), polypropylene (PP), polydimethylsiloxane (PDMS), polyimide (PI), colorless polyimide (CPI), perfluoropolyether (PFPE), polyurethane (PU), polycarbonate (PC), polystyrene (PS), polyester, and polyamide, etc. may be used as the base resin. Among these, polyvinylidene fluoride is preferable in that it is a thermoplastic material that exists in a powder form at room temperature, melts during a baking process in the powder coating process, and then returns to a solid state, and has excellent radiative cooling characteristics.

In the present disclosure, when the base resin is a thermoplastic such as PVDF, fusion occurs by heat treatment, the metamaterial is prepared, and a transparent metamaterial coating in the form of a film is formed upon returning to room temperature. Here, the heat treatment temperature may be 150° C. or more, preferably 150 to 350° C.

On the other hand, if the base resin is thermosetting, such as PDMS, curing occurs by heat treatment and a transparent metamaterial coating in the form of a film is formed. If a thermosetting resin is used as the base resin, a curing agent may be added as needed. Here, the heat treatment temperature may be 130° C. or more, preferably 80 to 120° C.

In an exemplary embodiment of the present disclosure, the base resin may be a light-transmissive polymer resin having a refractive index of 1.2 to 1.8, specifically 1.3 to 1.7, for example, 1.4 to 1.6. In the present disclosure, both radiative cooling characteristics and visible light transmittance may be improved by adjusting a difference in refractive index between the base resin and the optical modulator.

The aerogel particles are micro-level particle agglomerates formed by agglomeration of primary particles having a particle size of 5 to 50 nm, preferably 10 to 30 nm, wherein the particle size of the aerogel particles may be 0.1 to 100 μm, for example 2 to 25 μm.

One or more of silica (SiO₂) aerogels, titania (TiO₂) aerogels, carbon aerogels, graphene aerogels, etc. may be used as the aerogel particles.

The aerogel particles may be included in an amount of 10 wt %, based on the total weight of the parent resin, the aerogel particles, and the optical modulator. If the content of the aerogel particles is too low, the emissivity may be insufficient. If the content of aerogel particles is too high, transparency may be reduced.

When the aerogel particles are applied to the base resin to impart infrared radiation characteristics, a problem occurs in which visible light transmittance is reduced due to the aerogel particles. In the present disclosure, this problem can be solved through the introduction of an optical modulator, thereby providing a metamaterial with high infrared emissivity and excellent visible light transmittance.

The nanopore air layer of the aerogel particles causes reflection due to scattering. When an optical modulator having a refractive index similar to that of the base resin is used together with the aerogel particles upon the powder coating according to the present disclosure, it is possible to prevent a decrease in visible light transmittance caused by the aerogel particles through their combination.

The optical modulator used in the present disclosure is an organic compound, and one having a refractive index similar to that of the base resin may be used. Specifically, a material having an absolute value of a difference in refractive index from the base resin of 0.05 or less, preferably 0.03 or less, and more preferably 0.02 or less, may be used as the optical modulator. Accordingly, when an optical modulator is used in combination with the aerogel particles, radiative cooling performance may be improved while suppressing a decrease in transmittance and haze factor in a visible light region.

In an exemplary embodiment of the present disclosure, when a PVDF having a refractive index of about 1.42 is used as the base resin, a material having a refractive index of 1.39 to 1.45, and preferably 1.42 to 1.44 may be used as the optical modulator.

Specific examples of the optical modulator include eicosane (n=1.431), n-hexadecane (n=1.4329), and n-docosane (n=1.443), etc. Preferably, when eicosane is used as an optical modulator, a powder coating with excellent transparency may be formed due to its excellent matching with the refractive index of the base resin.

The aerogel particles and optical modulator may be used in a weight ratio of 1:4 to 1:50, preferably 1:5 to 1:30. In the above range, the pores of the aerogel particles may be sufficiently impregnated with the optical modulator to improve visible light transmittance.

Further, a weight ratio of the base resin and the aerogel may be 10:0.2 to 10:5, preferably 10:0.5 to 10:2. In the above weight range, the complex of the aerogel particles and the optical modulator may be appropriately dispersed in the base resin to improve emissivity and transmittance.

According to the present disclosure, by using aerogel particles and an optical modulator in combination and applying it to a powder coating process, a metamaterial coating with suppressed visible light scattering reflection may be formed while the emission effect by the aerogel particles is enhanced. In this regard, in Examples of the present disclosure, it was confirmed that the heat dissipation effect of the aerogel particles was not impaired by the addition of the optical modulator upon the powder coating, and that excellent cooling characteristics were exhibited, similar to the case where only the aerogel particles were added. On the other hand, it was confirmed that when powder coating was performed using only the base resin and aerogel particles without optical modulators, the visible light transmittance was 50% or less, indicating opacity, while when the aerogel particles were used with optical modulator, the transmittance was significantly improved to 70% or more.

A metamaterial film formed by using powder coating accordance to the present disclosure may have a transmittance of 70% or more, specifically 70 to 95% in the visible light region (wavelength 400 to 800 nm). In addition, the surface roughness (Ra) may be adjusted to 5 to 50 μm, for example, 10 to 30 μm. The haze factor may be adjusted in a range of 20 to 60%, for example, 30 to 50%, depending on the surface roughness and the internal porous structure.

The metamaterial in the form of a film formed by the powder coating of the present disclosure may have a thickness of 1 μm to 1 mm, and since the powder coating is utilized, a coating having a thickness of 50 μm or less may be easily formed. Preferably, the metamaterial film may have a thickness of 10 to 100 μm, more preferably 15 to 50 μm. The metamaterial film formed by using the present disclosure may exhibit excellent heat dissipation even with such a thin thickness.

That is, according to the present disclosure, even with powder coating, there is no decrease in physical properties compared to the liquid coating process, and a metamaterial coating with excellent emissivity and visible light transmittance may be formed even with a thin thickness. In addition, unlike liquid coatings, it is possible to form a uniform coating even on the object to be coated with three-dimensional structures, making it useful as a radiative cooling coating for various heat dissipation members such as a heat sink, a heat dissipation fin, a cooling plate, a solar cell, etc.

### EXAMPLES

Hereinafter the present disclosure will be described in more detail through Examples. However, these Examples show some experimental methods and compositions to illustratively illustrate the present disclosure, and the scope of the present disclosure is not limited to these Examples.

### Preparation Example 1: Preparation of PVDF Metamaterial Coating Using Powder Coating

Using polyvinylidene fluoride (PVDF) as a base resin, SiO₂ aerogel particles (SAPs) as aerogel particles, and eicosane as an optical modulator, a transparent metamaterial in the form of a film was prepared by powder coating.

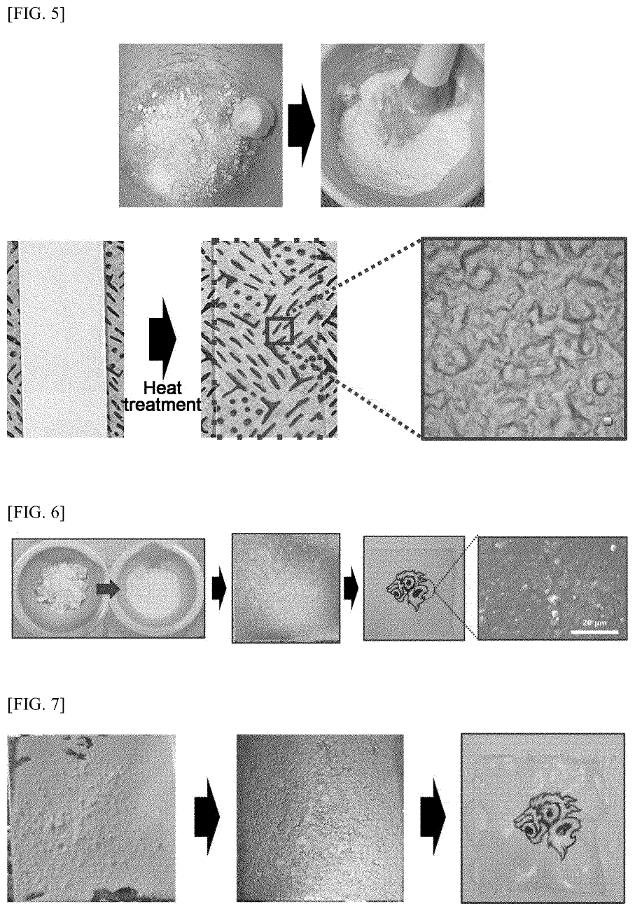

As shown in FIG. 5, 1 g of SiO₂ aerogel particles, 5 g of eicosane, and 10 g of PVDF were mixed and then powdered. The prepared powder was put into a hopper to fluidize the powder, and the fluidized powder was charged through a spray gun. The charged powder was powder-coated on a grounded surface to be coated with a uniform thickness by electrostatic attraction to form a metamaterial coating, and heat-treated at 200° C. to form a transparent metamaterial with a thickness of 25 μm.

### Preparation Example 2: Preparation of PDMS Metamaterial Coating Using Powder Coating (1)

Using polydimethylsiloxane (PDMS) as a base resin, SiO₂ aerogel particles (SAPs) as aerogel particles, and eicosane as an optical modulator, a transparent metamaterial in the form of a film was prepared by powder coating. A weight ratio of each component was set to the same conditions as in Preparation Example 1.

As shown in FIG. 6, the SiO₂ aerogel particles and the optical modulator were first mixed and powdered in the liquid phase, and then the prepared powder was put into a hopper to fluidize the powder, and the fluidized powder was charged through a spray gun. A powder layer was formed by powder coating charged powder on a grounded surface to be coated with a uniform thickness by electrostatic attraction. The powder layer was spin-coated with liquid PDMS and thermally cured at 100° C. to prepare a transparent metamaterial with a thickness of 25 μm.

### Preparation Example 3: Preparation of PDMS Metamaterial Coatings Using Powder Coating (2)

Using the same material as in Example 2, a metamaterial coating was formed by sequentially forming an aerogel particle, an optical modulator, and a base resin layer.

As shown in FIG. 7, the SiO₂ aerogel particles were placed into a hopper to fluidize powder fluidization, and the fluidized powder was charged through a spray gun. Charged powder was powder-coated to a uniform thickness by electrostatic attraction on a grounded substrate to be coated to form a powder layer, and then coated with a liquid optical modulator. The coating layer was spin-coated with PDMS and thermally cured at 100° C. to prepare a transparent metamaterial with a thickness of 25 μm.

### Experimental Example 1: Analysis of Transmittance and Radiative Cooling Characteristics of Metamaterials Prepared by Using Powder Coating

A transparent metamaterial was prepared by powder coating using the process of Preparation Example 1, and its visible light transmittance was measured in the wavelength region of 400 to 800 nm.

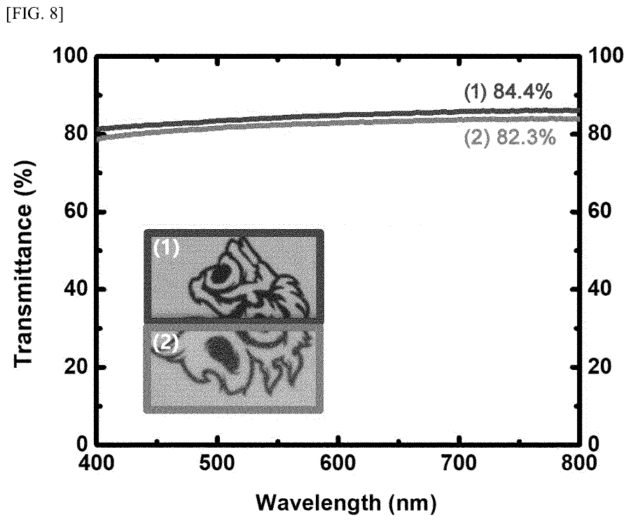

FIG. 8 is a graph illustrating a result of measuring the visible light transmittance, wherein when only the base resin (1) was coated, the measured visible light transmittance was 84.4%, and when coated in the form of a metamaterial (2), the measured visible light transmittance was 82.3%, resulting in no significant difference.

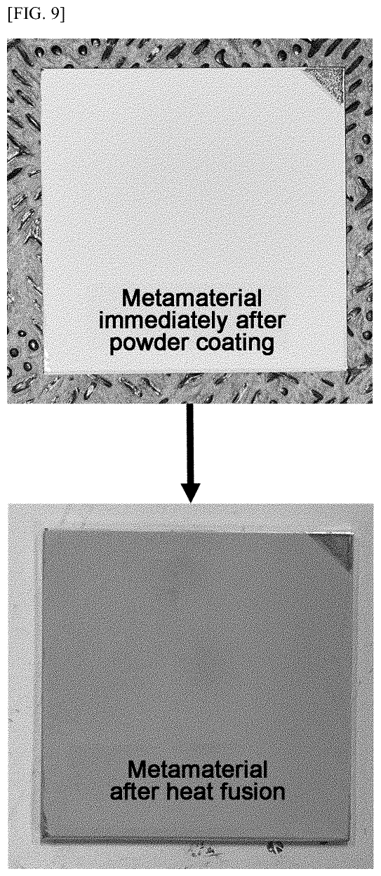

In addition, as shown in FIG. 9, a metamaterial coating was formed on an aluminum substrate by powder coating, thermally fused, and then a temperature change over time was measured to confirm radiant cooling characteristics. For comparison, the temperature change was also measured on a pure aluminum substrate.

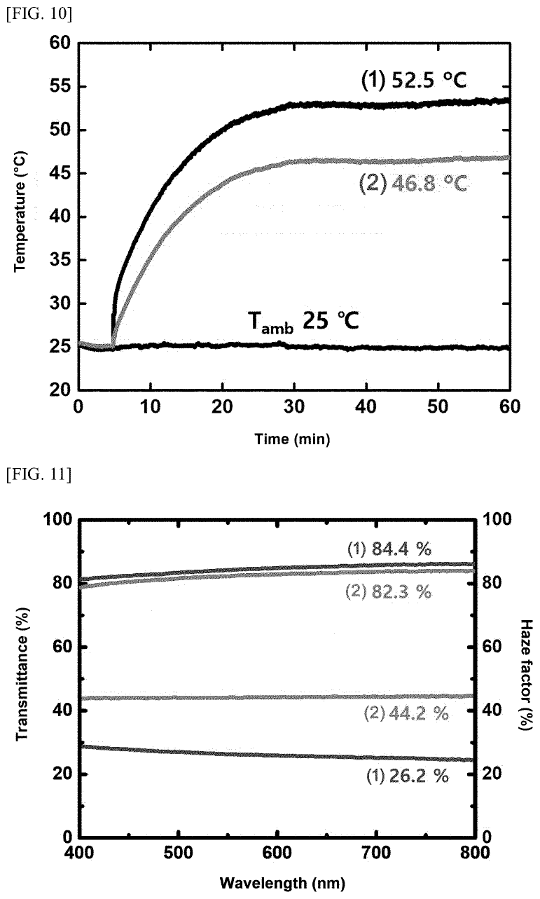

FIG. 10 is a graph illustrating a result of measuring the temperature change, wherein it was confirmed that the temperature of the pure aluminum substrate (1) increased to 52.5° C. after 60 minutes, while when the metamaterial (2) prepared using PVDF, SiO₂ aerogel particles and eicosane was coated, the temperature was 46.8° C. after 60 minutes, which was 5.7° C. or less.

Accordingly, it was found that the metamaterial formed by powder coating according to the present disclosure has excellent transparency and heat dissipation performance.

### Experimental Example 2: Analysis of Surface Roughness and Optical Characteristics of Metamaterial Coating Using Powder Coating

For the transparent metamaterial prepared by powder coating with the process of Preparation Example 1, the surface roughness was confirmed and the visible light transmittance and haze factor were measured in the wavelength region of 400 to 800 nm. For comparison, the same experiment was performed on a pure PVDF layer.

FIG. 11 is a graph illustrating a result of measuring the visible light transmittance and haze factor. It was confirmed that the pure PVDF layer (1) had a visible light transmittance of 84.4%, and the metamaterial (2) of the present disclosure had a transmittance of 82.3%, resulting in no significant difference. On the other hand, it was confirmed that the haze factor increased by about 18% compared to pure PVDF.

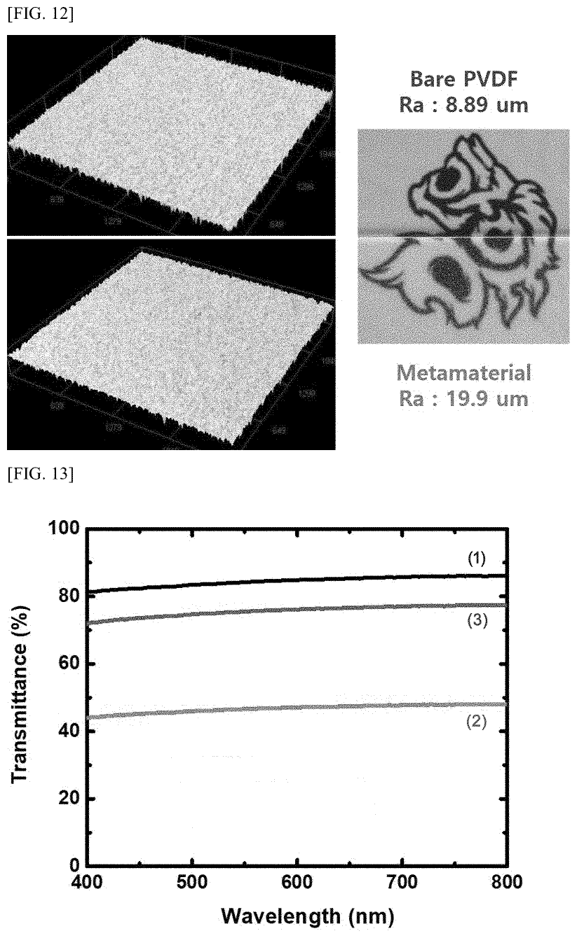

FIG. 12 illustrates a result of measuring the surface roughness for each specimen, wherein the measured surface roughness (Ra) of the pure PVDF layer was 8.89 μm, while the measured surface roughness of the metamaterial layer was 19.9 μm. It could be confirmed that the difference in haze factor was caused by such surface roughness and internal porous structure as described above, and the haze factor could be adjusted by adjusting the surface characteristics.

### Experimental Example 3: Analysis of Optical Characteristics of Metamaterial Coating with and without Eicosane

For a transparent metamaterial prepared by powder coating using the process of Preparation Example 1, the visible light transmittance was measured in the wavelength region of 400 to 800 nm.

FIG. 13 is a graph illustrating a result of measuring the visible light transmittance. It was confirmed that when only PVDF (1), which is the base resin, was coated, the visible light transmittance was high as high 80% or more, while when a mixture of PVDF and aerogel (2) was powder coated, the visible light transmittance was significantly reduced to 50% or less. Accordingly, it was confirmed that mixing the aerogel for heat dissipation performance resulted in a decrease in transparency.

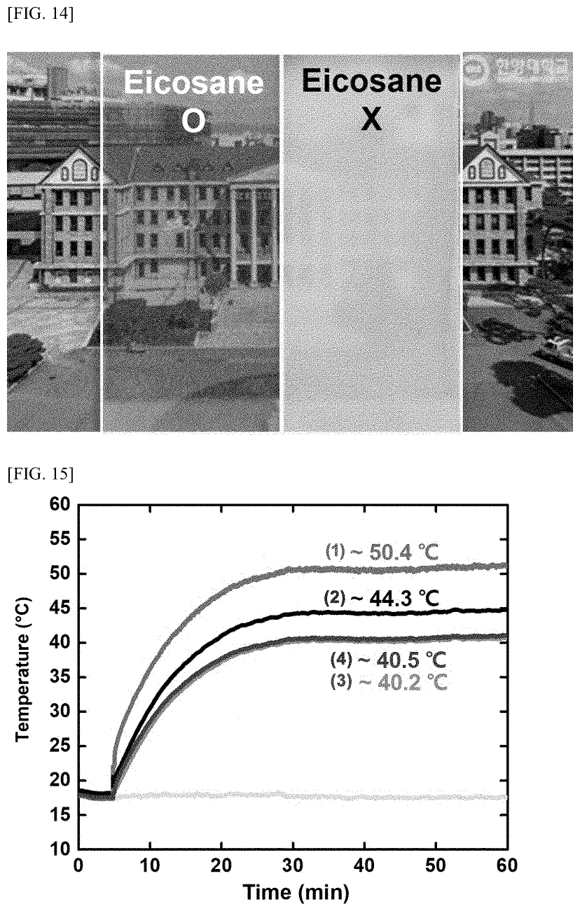

However, when eicosane, an optical modulator, was used together according to the present disclosure, this problem was solved, and when a mixture of PVDF, aerogels and eicosane (3) was powder coated, a visible light transmittance was 70% or more. That is, in the present disclosure, it was confirmed that a coating with excellent transparency could be formed even if the aerogel was added by using aerogel particles with optical modulator in combination. Referring to the photograph in FIG. 14, such a difference in transparency can be clearly confirmed.

In addition, a metamaterial coating was formed on an aluminum substrate by powder coating, and the temperature change over time was measured to confirm the radiative cooling characteristics, and the results are shown in FIG. 15. For comparison, temperature changes were also measured for a pure aluminum substrate, a substrate on which a base resin was formed, and a film made without the addition of eicosane.

Referring to the experimental results, it was confirmed that after 60 minutes, the temperature of the metal substrate (1) increased to 50.4° C., and when the PVDF coating (2), which is the base resin, was formed, the temperature increased to 44.3° C., while when the coating (3) with aerogel added to the base resin was formed, the temperature was 40.2° C., showing a cooling effect. In addition, it was confirmed that even when the coating (4) mixed with aerogels and eicosane was applied to the base resin, the temperature was 40.5° C., and there was little difference in temperature compared to the case of adding only aerogels.

Accordingly, it was confirmed that the optical modulator used in the present disclosure may significantly improve the transparency without impairing the heat dissipation effect of the aerogels.

### Experimental Example 4: Analysis of Optical and Heat Dissipation Characteristics of Metamaterial Coating

A transparent metamaterial was prepared by a method of Preparation Example 2. For comparison, a liquid mixture mixed with aerogel particles, optical modulators, and PDMS was coated to prepare a metamaterial film. In each film, a ratio of the mixing amounts of aerogels and optical modulator to the total amount of metamaterial was adjusted to 30 and 40% by volume, respectively.

For each film, the transmittance (%) was measured in a visible wavelength band and is shown in Table 1.

TABLE 1

| Coating method | vol % | Transmittance |
|---|---|---|
| Powder coating | 30 | 91.8 |
| | 40 | 90.5 |
| Liquid coating | 30 | 91.5 |
| | 40 | 91.3 |

Referring to Table 1, it could be confirmed that the metamaterial film prepared by powder coating after powdering according to the present disclosure had transmittances of 91.8 and 90.5%, respectively, under the condition that the mixture was 30 and 40% by volume, and the metamaterial film prepared by the liquid process had a transmittance of 91.5 and 91.3%, respectively, under the conditions that the mixture was 30 and 40% by volume, indicating that the visible light transmittances of the metamaterial film prepared by powder coating and the metamaterial film prepared by the liquid process were similar.

In addition, haze factor (%) was measured in the visible wavelength band for each film and the results are shown in Table 2.

TABLE 2

| Coating method | vol % | Haze factor |
|---|---|---|
| Powder coating | 30 | 0.19 |
| | 40 | 0.23 |
| Liquid coating | 30 | 0.20 |
| | 40 | 0.25 |

Referring to Table 2, it was confirmed that the metamaterial film prepared by the powder coating according to the present disclosure had a haze factor of 0.19 and 0.23, respectively, under the condition that the mixture was 30 and 40% by volume, and the metamaterial film prepared by the liquid process had a haze factor of 0.20 and 0.25, respectively, under the condition that the mixture was 30 and 40% by volume, indicating that there was little difference in haze factor between the metamaterial film prepared by the powder coating and the metamaterial film prepared by the liquid process.

Based on the above results, it was confirmed that the optical characteristics of the metamaterial were not degraded by the powder coating of the metamaterial according to the present disclosure, and were maintained at a level similar to that of the liquid coating process.

### Experimental Example 5: Analysis of Heat Dissipation Characteristics of Metamaterial Coating

A transparent metamaterial was prepared by using a method of Preparation Example 3. For the solar cell using the metamaterials, the temperature change over time was measured to confirm radiative cooling characteristics, and the results are shown in FIG. 16. For comparison, the temperature changes were also measured for a solar cell without a coating layer and for metamaterials formed by a liquid coating process.

Referring to the experimental results, it can be confirmed that after 100 minutes, the temperature of the bare solar cell (1) increased to 66.6° C., but when the metamaterial powder coating (2) was applied by powder coating the SiO₂ aerogel, coating the optical modulator, and coating the base material, the temperature was 59.0° C., showing a large difference of 7.6° C. Furthermore, through comparison with the case of applying the metamaterial (3) formed by liquid coating, it was confirmed that there was no difference in the cooling effect from liquid coating even when powder coating was applied.

### Experimental Example 6: Application of Metamaterial Powder Coating to Heat Sink

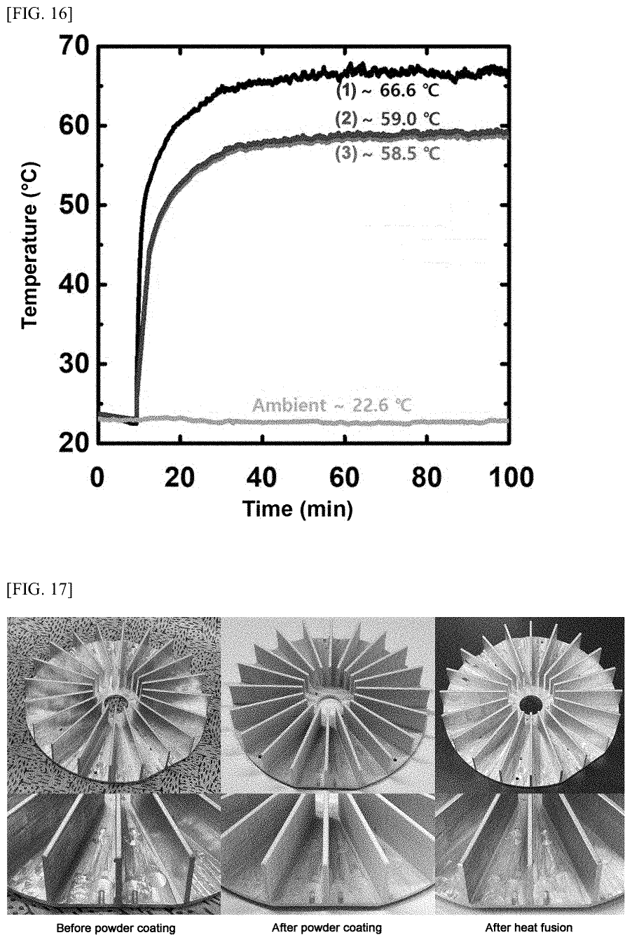

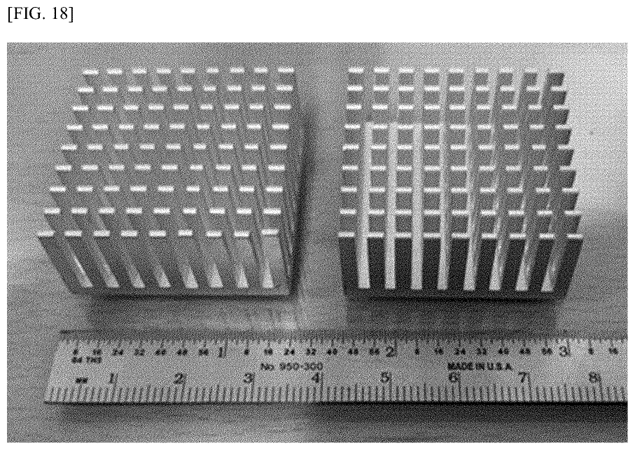

A metamaterial coating was formed on a heat sink (heat dissipation plate) by a method of Preparation Example 1, and photographs before and after the coating formation are shown in FIGS. 17 and 18.

Referring to FIG. 17, it can be confirmed that an overall uniform coating is possible even on a heat dissipation plate with a complex structure. Furthermore, FIG. 18 illustrates a photograph taken by powder coating a heat dissipation plate of 3.5 cm×3.5 cm with the metamaterial. As a result of measuring the gap between the fins before and after the powder coating was measured, it was confirmed that the gap between the fins was reduced by about 50 μm. It was confirmed that the gap between the pins to be coated was about 1.5 mm, and it was possible to coat uniformly even with such a small gap between the fins.

As the specific parts of the present disclosure have been described in detail above, it will be obvious to those skilled in the art that these specific techniques are merely preferred embodiments and do not limit the scope of the present disclosure. Therefore, it will be said that the substantial scope of the present disclosure is defined by the appended claims and their equivalents.

The invention claimed is:

1. A method for preparing a metamaterial, the method comprising:
mixing and solidifying aerogel particles, an optical modulator, and a base resin to prepare a powder;
powder coating the powder to form a powder layer; and
heat treating the powder layer to form a metamaterial in the form of a film.

2. A method for preparing a metamaterial, the method comprising:
mixing and solidifying aerogel particles and an optical modulator to prepare a powder;
powder coating the powder and then coating a base resin to form a powder layer coated with the base resin, or mixing the powder with a base resin and then powder coating it; and
heat treating the powder layer to form a metamaterial in the form of a film.

3. A method for preparing a metamaterial, the method comprising:
powder coating aerogel particles to form a powder layer;
coating the powder layer with an optical modulator;
coating the optical modulator-coated layer with a base resin; and
heat treating the powder layer coated with the optical modulator and base resin to form a metamaterial in the form of a film.

4. The method of claim 1,
wherein the powder coating is performed by an electrostatic spray method or a fluidized bed method.

5. The method of claim 1,
wherein the heat treatment is performed at a temperature condition of 80 to 380° C.

6. The method of claim 1,
wherein the base resin has a refractive index of 1.2 to 1.8.

7. The method of claim 1,
wherein the base resin is one or more selected from the group consisting of polyvinylidene fluoride (PVDF), 2,2,2-trifluoroethyl methacrylate (TFEMA), polyethylene (PE), polypropylene (PP), polydimethylsiloxane (PDMS), polyimide (PI), colorless polyimide (CPI), perfluoropolyether (PFPE), polyurethane (PU), polycarbonate (PC), polystyrene (PS), polyester, and polyamide.

8. The method of claim 1,
wherein the aerogel particles are one or more selected from the group consisting of silica (SiO₂) aerogels, titania (TiO₂) aerogels, carbon aerogels, and graphene aerogels.

9. The method of claim 1,
wherein the optical modulator is an organic compound having a difference in refractive index of 0.05 or less from the base resin.

10. The method of claim 1,
wherein the optical modulator is one or more selected from the group consisting of eicosane, n-hexadecane, and n-docosane.

11. The method of claim 1,
wherein a particle size of the powder is 100 nm to 25 μm.

12. The method of claim 1,
wherein the metamaterial in the form of a film has a thickness of 1 μm to 1 mm.

13. The method of claim 1,
wherein the metamaterial in the form of a film has a visible light transmittance of 70% or more.

14. The method of claim 1,
wherein the metamaterial in the form of a film has a surface roughness (Ra) of 5 to 50 μm.

15. The method of claim 1,
wherein the object to be coated, on which the metamaterial in the form of a film is formed is a heat sink, a heat dissipation fin, a cooling plate, or a solar cell.
